(19) United States
(12) Patent Application Publication
(10) Pub. No.: US 2018/0023632 A1
(43) Pub. Date: Jan. 25, 2018

(54) LINING CARRIER FOR A WET RUNNIN FRICTION LINING

(71) Applicant: SCHAEFFLER TECHNOLOGIES AG & CO. KG, Herzogenaurach (DE)

(72) Inventor: Atsushi NISHIYAMA, Buhl (DE)

(73) Assignee: Schaeffler Technologies AG & Co. KG, Herzogenaurach (DE)

(21) Appl. No.: 15/548,305

(22) PCT Filed: Feb. 26, 2016
(86) PCT No.: PCT/DE2016/200111

§ 371 Date: Aug. 2, 2017

(30) Foreign Application Priority Data
Feb. 27, 2015 (DE) 10 2015 203 503.4

(51) Int. Cl. F16D 13/64

(52) U.S. Cl. CPC F16D 13/648

(57) ABSTRACT

The invention relates to a lining carrier for at least one wet running friction lining that is formed from a wet running friction lining material. The lining carrier may further be formed from a dry running friction lining material.

### BACKGROUND

The invention relates to a lining carrier for at least one wet running friction lining, which is formed from a wet running friction lining material. The invention further relates to a wet running clutch part having such a lining carrier. The invention also relates to a wet running counter clutch part with a friction lining.

A friction plate for wet running friction clutch modules is known from the European patent publication EP 1 910 704 B1 for the use in automotive drivetrains of passenger vehicles and trucks, which comprise an annular polymer core plate and a friction lining, which is connected to the core plate.

### SUMMARY

The objective of the invention is to simplify and/or improve the production and/or functionality of wet running clutch parts, particularly clutch disks.

The objective is attained in a lining carrier for at least one wet running friction lining, which is formed by a wet running friction lining material in which the lining carrier comprises dry running friction lining materials. For dry running applications different friction linings are used than for wet running applications. Dry running friction linings are used for example in passenger vehicles, trucks, and tractors. Dry running friction linings have for example external diameters from one hundred eighty to four hundred thirty millimeters. Wet running friction linings are used in the automotive field for example for converter bridge clutches, for torque converters, and for duplex clutches. In wet running friction linings a coolant and/or lubricant is used, such as oil, in order to dissipate heat developing during the operation of the wet running friction linings. The coolant or lubricant also serves to improve the reaction behavior of a clutch equipped with a wet running friction lining and/or to reduce operating noise during the use of the clutch. In dry running friction linings such coolants or lubricants are not used. According to an essential aspect of the invention the lining carrier for the wet running friction lining is not made from a steel material, as presently common, or a polymer material, but at least partially from a dry running friction lining material. According to the present invention the dry running friction material is therefore not used to form the friction lining, rather it serves as a lining carrier for a friction lining, which is not dry running.

A preferred exemplary embodiment of the lining carrier is characterized in that the lining carrier is formed from dry running friction lining materials. According to another aspect of the invention the lining carrier according to the invention is made entirely from a dry running friction lining material. For the production of the lining carrier made from dry running friction lining material advantageously the same method or a similar method can be used as for the production of dry running friction linings.

Another preferred exemplary embodiment of the friction lining carrier is characterized in that the lining carrier comprises a circular, disk-shaped basic body, which is formed entirely from the dry running friction lining material. The lining carrier made from the dry running friction lining material has advantageously the same shape as conventional lining carriers made from steel materials. For example, the lining carrier made from the dry running friction lining material may have gears radially inside or radially outside, which serve to generate a torque-proof connection to a disk carrier of a disk clutch.

The invention further relates to a wet running clutch part with an above-described lining carrier, to which at least one wet running friction lining is fastened. The wet running friction lining is connected to the lining carrier, for example positively bonded to the lining carrier. The positive bond can be embodied as an adhesion, for example. Alternatively or additionally the wet running friction lining can be fastened at the lining carrier with the help of fastening elements, such as rivet connection elements.

A preferred exemplary embodiment of the wet running clutch part is characterized in that the wet running clutch part is a wet running clutch disk. The wet running clutch disk is for example one of several clutch disks of a wet running multiple disk clutch.

The invention further relates to a wet running counter clutch part with a friction surface. The wet running counter clutch part comprises a friction surface, which is also called counter surface, because in the installed state it comes into contact with a friction surface of an above-described clutch part. According to another aspect of the invention the wet running counter clutch part is made at least partially from dry running friction lining material. In a clutch device, for example a multiple disk clutch which is equipped with at least one above-described clutch part and an above-mentioned counter clutch part, therefore a wet running friction lining comes into contact with a counter surface or a friction surface made from dry running friction lining material.

A preferred exemplary embodiment of the wet running counter clutch part is characterized in that the wet running counter clutch part is made from dry running friction lining material. According to another aspect of the invention the wet running counter clutch part is formed entirely from dry running friction lining material. The counter clutch part made from the dry running friction lining material replaces for example a conventional steel disk in a multiple disk clutch.

Another preferred exemplary embodiment of the wet running counter clutch part is characterized in that the wet running counter clutch part comprises a circular disk-shaped basic body, which is formed entirely from dry running friction lining materials. The shape of the wet running counter clutch part can be identical or similar to a conventional steel disk of a multiple disk clutch. For example, the wet running counter clutch part may be equipped with gears, for example radially inside or radially outside, which serve to generate a torque-proof connection to a disk carrier of a disk clutch.

Another preferred exemplary embodiment of the wet running counter clutch part is characterized in that the wet running counter clutch part is a wet running clutch disk. In the embodiment of the wet running counter clutch part according to the invention dry running friction lining materials come into contact with a coolant and/or lubricant, as used in wet running clutch applications.

The invention further relates to a disk package with the above-described wet running clutch parts and the above-described wet running counter clutch parts. The wet running clutch parts are preferably arranged alternating with the wet running counter clutch parts in a manner known per se. Within the scope of the present invention the use of dry running friction lining material yields, among other things, advantages with regards to weight. The dry running friction lining material is considerably lighter than steel material. Additionally, the dry running friction lining material has pores, similar to the steel material of prior art, maintaining and/or improving the function of the friction pairs during operation of a clutch equipped with the clutch parts, particularly of a multiple disk clutch. Due to the low weight the fuel consumption can be reduced of a motor vehicle equipped with such a clutch device. Furthermore, the dry running friction lining material tolerates higher temperatures. According to another aspect of the invention the capacity of the clutch device for transmitting torque can be improved by the multiple disk package according to the invention. This is caused in particular by the higher friction coefficients between the wet running friction lining material and the dry running friction lining material.

### BRIEF DESCRIPTION OF THE DRAWINGS

Additional advantages, features, and details of the invention are discernible from the following description, in which various exemplary embodiments are described in detail with reference to the drawings. Shown are:

FIG. 1 shows a cross-section of a largely simplified illustration of a lining carrier according to the invention with two wet running friction linings;

FIG. 2 shows an arrangement of the lining carrier with the wet running friction linings of FIG. 1 between two counter clutch parts made from a dry running friction lining material; and

FIG. 3 shows a simplified illustration of a disk package according to the invention with wet running clutch parts and with wet running counter clutch parts made from dry running friction lining materials.

### DETAILED DESCRIPTION OF THE CLAIMS

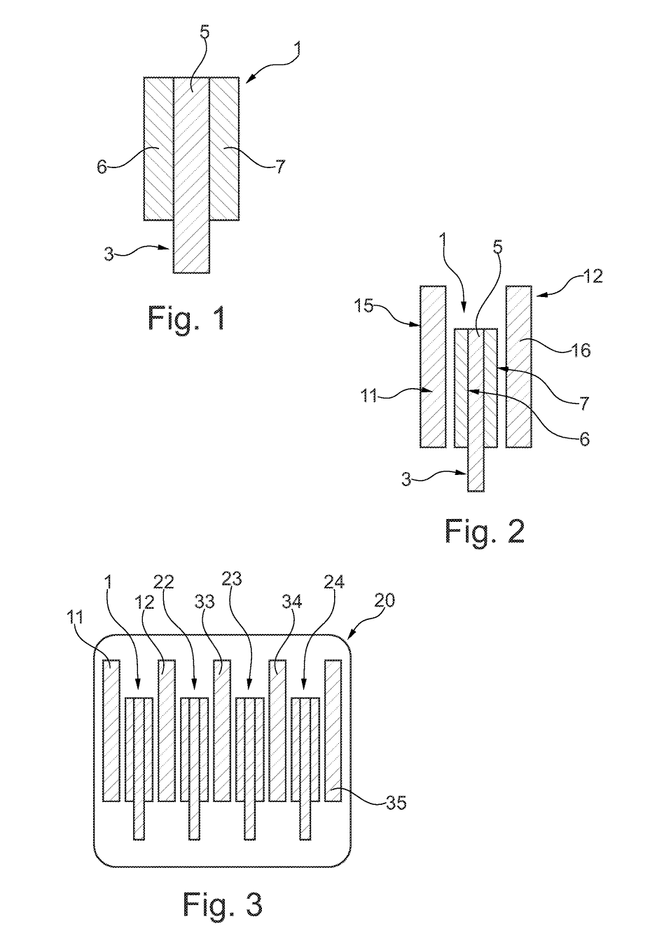

FIG. 1 shows a wet running clutch part 1 with a lining carrier 3, largely simplified and in a cross-section. The lining carrier 3 comprises a basic body 5, which essentially has the shape of a circular disk with a rectangular cross-section of the ring.

Two wet running friction linings 6, 7 are fastened on the basic body 5. The wet running friction linings 6, 7 are the shape of circular disks with a rectangular cross-section of the ring. The wet running friction linings 6, 7 have the same exterior diameter as the basic body 5 of the lining carrier 3. The lining carrier 3 has a smaller interior diameter than the wet running friction linings 6, 7.

The wet running clutch part 1 represents for example an interior disk of a multiple disk clutch. In order to generate a torque-proof connection to an internal disk carrier of the multiple disk clutch the lining carrier 3 has at the inside radial gears, for example.

FIG. 2 shows the wet running clutch part 1 of FIG. 1 arranged between two wet running counter clutch parts 11, 12. The two counter clutch parts 11, 12 each have a basic body 15, 16 in the form of a circular disk with a rectangular cross-section of the ring.

An internal diameter of the basic body 15, 16 of the counter clutch parts 11, 12 has the same size as the internal diameter of the wet running friction linings 6, 7 in the lining carrier 3. However, the counter clutch parts 11, 12 have a greater external diameter than the lining carrier 3 with the wet running friction linings 6, 7.

Counter clutch parts 11, 12 represent for example external disks of the above-described multiple disk clutch. In order to generate a torque-proof connection to an external disk carrier the counter clutch parts 11, 12 are advantageously equipped radially at the outside with outer gears.

The wet running friction linings 6, 7 at the lining carrier 3 are made from a wet running friction lining material, of course. Unlike that, the lining carrier 3 is made from a dry running friction lining material. The lining carrier 3 made from a dry running friction lining material therefore replaces a conventional lining carrier made from steel materials.

Furthermore, the counter clutch parts 11, 12 are also made from a dry running friction lining material. Advantageously the counter clutch parts 11, 12 are made from the same dry running friction lining material as the lining carrier 3.

FIG. 3 shows in a simplified fashion a disk package 20 of a multiple disk clutch. The disk package 20 comprises, in addition to the wet running clutch part 1, wet running clutch parts 22, 23, and 24. The wet running clutch parts 22 to 24 are embodied identically to the wet running clutch part 1. The wet running clutch parts 1, 22 to 24 represent the internal disks in the disk package 20.

The disk package 20 comprises furthermore, in addition to the counter clutch parts 11, 12 of FIG. 2, three other wet running counter clutch parts 33, 34, 35. The wet running clutch parts 1, 22 to 24 are arranged alternating with the wet running counter clutch parts 11, 12, 33 to 35.

The counter clutch parts 11, 12 and 33 to 35 represent external disks of the disk package 20. Here, the counter clutch part 11 represents an end disk of the disk package 20 at the left in FIG. 3. Similarly the counter clutch part 35 arranged at the right in FIG. 3 represents a second end disk of the disk package 20. The wet running clutch parts 1, 22 to 24 are respectively arranged between two counter clutch parts 11, 12; 12, 33; 33, 34; 34, 35.

### LIST OF REFERENCE CHARACTERS

1 clutch part
3 lining carrier
5 basic body
6 wet running friction lining
7 wet running friction lining
11 counter clutch part
12 counter clutch part
15 basic body
16 basic body
20 disk package
22 clutch part
23 clutch part
24 clutch part
33 counter clutch part
34 counter clutch part
35 counter clutch part

1. A lining carrier for at least one wet running friction lining made from a wet running friction lining material the lining carrier comprising dry running friction lining materials.

2. The lining carrier according to claim 1, wherein the lining carrier is made entirely from the dry running friction lining materials.

3. The lining carrier according to claim 1, wherein the lining carrier comprises a circular disk-shaped basic body formed entirely from the dry running friction lining materials.

4. A wet running clutch part comprising a lining carrier according to claim 1, and at least one wet running friction lining fastened to the lining carrier.

5. The wet running clutch part according to claim 4, wherein the wet running clutch part is a wet running clutch disk.

6. A wet running counter clutch part with a friction surface, the wet running counter clutch part comprises dry running friction lining materials.

7. The wet running counter clutch part according to claim 6, wherein the wet running counter clutch part is formed entirely from dry running friction lining materials.

8. The wet running counter clutch part according to claim 6, wherein the wet running counter clutch part comprises a circular disk-shaped basic body formed entirely from dry running friction lining materials.

9. The wet running counter clutch part according to claim 6, wherein the wet running counter clutch part is a wet running clutch disk.

10. A disk package comprising the wet running clutch part according to claim 4 and a wet running counter clutch part formed from dry running friction lining materials.
